(19) United States
(12) Patent Application Publication
(10) Pub. No.: US 2017/0022897 A1
(43) Pub. Date: Jan. 26, 2017

(54) METHOD AND INSTALLATION FOR STORING AND RECOVERING ENERGY

(71) Applicants: LINDE AKTIENGESELLSCHAFT, München (DE); MITSUBISHI HITACHI POWER SYSTEMS EUROPE GMBH, Duisburg (DE)

(72) Inventors: Alexander Alekseev, Wolfratshausen (DE); Christoph Stiller, Fürstenfeldbruck (DE); Brian Stöver, Recklinghausen (DE); Christian Bergins, Datteln (DE)

(21) Appl. No.: 15/302,326

(22) PCT Filed: Apr. 2, 2015
(86) PCT No.: PCT/EP2015/000718

§ 371 Date: Oct. 6, 2016

(30) Foreign Application Priority Data
Apr. 11, 2014 (DE) 102014005336.9
Jun. 3, 2014 (EP) 14001925.8

(51) Int. Cl. F02C 3/22; F25J 1/02; F25J 1/00

(52) U.S. Cl. CPC F02C 3/22; F25J 1/0012; F25J 1/0037; F25J 1/004; F25J 1/0042; F25J 1/0045; F25J 1/0201; F25J 1/0228; F25J 1/0242; F25J 1/0251; F25J 1/0264; F05D 2220/32; F05D 2240/35; F25J 2205/24; F25J 2205/32; F25J 2205/66; F25J 2205/70; F25J 2240/82; F25J 2240/90; F25J 2270/06

(57) ABSTRACT

A method and installation for storing and recovering energy, according to which a condensed air product is formed in an energy storage period, and in an energy recovery period, a pressure flow is formed and is expanded to produce energy using at least part of the condensed air product. For the formation of the condensed air product: the compression of air in an air conditioning unit, at least by means of at least one isothermally operated compressor device and the adsorptive cleaning of the air by means of at least one adsorptive cleaning device at a hyperbaric pressure level.

The invention relates to a method and an installation for storing and recovering energy, in particular electrical energy, according to the respective preambles of the independent patent claims.

### PRIOR ART

It is known for example from DE 31 39 567 A1 and EP 1 989 400 A1 to use liquid air or liquid nitrogen, that is to say low-temperature air liquefaction products, for grid control and provision of control capacity in electric power grids.

At times when electric power is inexpensive, or at times when there is a surplus of electric power, air is liquefied in an air separation installation with an integrated liquefier or in a dedicated liquefaction installation, also referred to generally as an air treatment unit, altogether or partially to form such an air liquefaction product. The air liquefaction product is stored in a system of tanks comprising low-temperature tanks. This operating mode takes place in a time period that is referred to here as the energy storage period.

At times of peak load, the liquefaction product is removed from the system of tanks, the pressure is increased by means of a pump and it is heated up to approximately ambient temperature or above, and is thereby transformed into a gaseous or supercritical state. A pressurized stream thereby obtained is expanded to ambient pressure in an energy production unit in an expansion turbine or a number of expansion turbines with intermediate heating. The mechanical power thereby released is transformed into electrical energy in one or more generators of the energy production unit and is fed into an electric grid. This operating mode takes place in a time period that is referred to here as the energy recovery period.

The cold released during the transformation of the liquefaction product into the gaseous or supercritical state during the energy recovery period can be stored and used during the energy storage period for providing cold to obtain the air liquefaction product.

There are also known compressed-air storage power plants, in which however the air is not liquefied but compressed in a compressor and stored in an underground cavern. At times when the demand for power is high, the compressed air is conducted out of the cavern into the combustion chamber of a gas turbine. At the same time, fuel, for example natural gas, is fed to the gas turbine by way of a gas line and is burned in the atmosphere formed by the compressed air. The exhaust gas that is formed is expanded in the gas turbine, whereby energy is generated.

The present invention can be distinguished from methods and devices in which an oxygen-rich liquid is introduced into a gas turbine to assist oxidation reactions. Corresponding methods and devices operate in principle with air liquefaction products that contain (significantly) more than 40 mole percent of oxygen.

The cost-effectiveness of corresponding methods and devices is strongly influenced by the overall efficiency. The invention is therefore based on the object of improving corresponding methods and devices in this respect.

### DISCLOSURE OF INVENTION

Against this background, the present invention proposes a method and an installation for storing and recovering energy, in particular electrical energy, with the features of the respective independent patent claims. Preferred refinements are respectively the subject of the dependent patent claims and the description that follows.

Before the advantages that are achievable in the context of the present invention are explained, the technical principles on which it is based and some of the terms used in this application are explained more specifically.

An “energy production unit” is understood here as meaning an installation or part of an installation that is designed for generating electrical energy. An energy production unit comprises at least one expansion turbine, which is coupled to at least one electric generator. An expansion machine coupled to at least one electric generator is usually also referred to as a “generator turbine”. In the context of the present application, a generator turbine is also understood as meaning an expansion stage of a gas turbine unit. The mechanical power released during the expansion of a fluid in the at least one expansion turbine or generator turbine can be converted in the energy production unit into electrical energy.

An “expansion turbine”, which may be coupled to further expansion turbines or energy converters such as oil brakes, generators or compressor stages, by way of a common shaft, is designed for the expansion of a supercritical, gaseous or at least partially liquid stream. In particular, for use in the present invention, expansion turbines may be designed as turbo expanders. If one or more expansion turbines designed as turbo expanders is/are only coupled to one or more compressor stages, for example in the form of radial compressor stages, and possibly mechanically braked, but the latter are operated without energy that is externally supplied, for example by means of an electric motor, the term “booster turbine” is also generally used for this. Such a booster turbine compresses at least one stream by the expansion of at least one other stream, but without energy that is externally supplied, for example by means of an electric motor.

A “gas turbine unit” is understood in the context of the present application as meaning an arrangement comprising at least one combustion chamber and at least one expansion turbine arranged downstream thereof (the gas turbine in the narrower sense). In the expansion turbine, hot gases from the combustion chamber are expanded to perform work. A gas turbine unit also has at least one compressor stage that is driven by the expansion turbine by way of a common shaft, typically at least one axial compression stage. Part of the mechanical energy generated in the expansion turbine is usually used for driving the at least one compressor stage. A further part is often converted in a generator for generating electrical energy. The expansion turbine of the gas turbine is consequently a generator turbine in the sense explained above.

As a modification of a gas turbine unit, a “combustion turbine unit” only has the mentioned combustion chamber and a downstream expansion turbine. A compressor is not usually provided. By contrast with a gas turbine unit, a “hot gas turbine unit” has a heater instead of a combustion chamber. A hot gas turbine unit may be formed in one stage with a heater and an expansion turbine. Alternatively, a number of expansion turbines, preferably with intermediate heating, may also be provided. In any case, a further heater may be provided, in particular downstream of the “last” expansion turbine. The hot gas turbine is also preferably coupled to one or more generators for generating electrical energy.

A “compressor device” is understood here as meaning a device which is designed for compressing at least one gaseous stream from at least one input pressure, at which it is fed to the compressor device, to at least one final pressure, at which it is removed from the compressor device. The compressor device in this case forms a structural unit, which however may comprise a number of individual “compressors” or “compressor stages” in the form of known piston, screw and/or bucket-wheel or turbine arrangements (that is to say radial or axial compressor stages). In particular, these compressor stages are driven by means of a common drive, for example by way of a common shaft or a common electric motor. A number of compressors, e.g. compressors in an air conditioning unit used according to the invention, can together form one or more compressor devices.

In the terminology used here, an “air conditioning unit” comprises at least one compressor device and at least one adsorptive purification device. Adsorptive purification devices are generally known in the field of air separation. In adsorptive purification devices, one or more air streams are conducted through one or more adsorber vessels, which are filled with a suitable adsorption material, for example a molecular sieve.

The present invention comprises at least the liquefaction of air to form an air liquefaction product. The devices used for this purpose may also be subsumed here under the term “air treatment unit”. In the terminology of the present application, this is understood as meaning an installation which is designed for obtaining at least one air liquefaction product from air. It is sufficient for an air treatment unit for use in the present invention that it can be used to obtain a corresponding low-temperature air liquefaction product that is usable as a storage liquid and is transferable into a system of tanks. An “air separation installation” is charged with atmospheric air and has a system of distillation columns for separating the atmospheric air into its physical components, in particular into nitrogen and oxygen. For this purpose, the air is initially cooled down to approaching its dew point and is then introduced into the system of distillation columns. By contrast with this, an “air liquefaction installation” does not comprise a system of distillation columns. Otherwise, it corresponds in its construction to that of an air separation installation with the delivery of an air liquefaction product. It goes without saying that liquid air can also be produced as a byproduct in an air separation installation.

An “air liquefaction product” is any product that can be produced at least by compressing, cooling and subsequently expanding air in the form of a low-temperature liquid. In particular, an air liquefaction product may be liquid air, liquid oxygen, liquid nitrogen and/or a liquid noble gas such as liquid argon. The terms “liquid oxygen” and “liquid nitrogen” also refer here respectively to a low-temperature liquid which comprises oxygen or nitrogen in a quantity that lies above that of atmospheric air. Therefore, they do not necessarily have to be pure liquids with high contents of oxygen or nitrogen. Liquid nitrogen is therefore understood as meaning both pure or substantially pure nitrogen and a mixture of liquefied gases of which the nitrogen content is higher than that of atmospheric air. For example, it has a nitrogen content of at least 90, preferably at least 99, mole percent.

When mention is made here of a “vaporization product”, this should be understood as meaning a fluid formed by transforming a liquid into a gaseous or supercritical state. If a liquid at supercritical pressure is “evaporated”, it does not go over into the gas phase but into the supercritical state, with no phase transition in the actual sense taking place. This is also referred to as “pseudo evaporation”. At subcritical pressure, a phase transformation takes place from the liquid state into the gaseous state, that is to say a conventional “evaporation”. Consequently, in the context of the present application, a vaporization comprises both an evaporation and a pseudo evaporation. In the case of a “liquefaction”, both gaseous and supercritical fluids go over into the liquid state.

A “low-temperature” liquid, or a corresponding fluid, air liquefaction product, stream etc., is understood as meaning a liquid medium of which the boiling point is significantly below the respective ambient temperature and is for example 200 K or less, in particular 220 K or less. Examples are liquid air, liquid oxygen, liquid nitrogen, etc.

In the context of this application, a “fixed-bed cold storage unit” is understood as meaning a device which contains a solid material suitable for storing cold and a fluid-conducting means through this material. Known fixed-bed cold storage units, which in conventional air separation installations are also referred to as regenerators and are used there also for separating off undesired components such as water and/or carbon dioxide, comprise for example concrete blocks permeated by channels (unusual in the case of air separation installations), (stone) fillings and/or corrugated aluminium sheets and are flowed through by the streams that are respectively to be cooled down or heated up in opposite directions and in different time periods. In the context of this application, the terms “hot store” and “cold store” are used synonymously. A cold storage unit comprises one or more cold stores. The heat storage media that can be used in one or more cold stores depend on the configuration of the process.

Fixed-bed cold stores are described in the relevant specialist literature (see for example I. Dincer and M. A. Rosen “Thermal Energy Storage—Systems and Applications”, Chichester, John Wiley & Sons 2002). Suitable for example as storage media are rock, concrete, brick, artificially produced ceramics or cast iron. Also suitable for lower storage temperatures are earth, gravel, sand or crushed rock. Further storage media such as thermal oils or molten salts are known for example from the field of solar technology. In corresponding cold stores, it may prove to be particularly advantageous to provide the storage medium in an isolating vessel, which makes loss-free or virtually loss-free cold storage possible.

A “counterflow heat exchanger unit” is formed in particular by using one or more counterflow heat exchangers, for example one or more plate heat exchangers. By contrast with a fixed-bed cold storage unit, the cooling in a counterflow heat exchanger unit does not take place by dissipating heat to or taking up heat from a fixed bed, but indirectly to and from a counterflowing heat or cold transfer medium. All known heat exchangers, for example plate heat exchangers, tubular heat exchangers and the like, are suitable for use in the present invention as heat exchangers in a counterflow heat exchanger unit. A counterflow heat exchanger unit serves for the indirect transfer of heat between at least two streams made to flow counter to one another, for example a warm stream of compressed air and one or more cold streams or a low-temperature air liquefaction product and one or more warm streams. A counterflow heat exchanger unit may be formed by a single or multiple heat exchanger portions that are connected in parallel and/or in series, for example one or more plate heat exchanger blocks. When a “heat exchanger” is mentioned hereinafter, this may be understood as meaning a counterflow heat exchanger or some other heat exchanger.

A “heater” is understood in the context of this application as meaning a system for the indirect heat exchange between a heating fluid and a gaseous fluid to be heated. By means of such a heater, residual heat, waste heat, process heat, solar heat, etc. can be transferred to the gaseous fluid to be heated and used for energy generation in a hot gas turbine.

Methods and devices for the low-temperature separation of air and the methods and devices that can be used there and also in the context of the present invention are also described for example in Haring, H.-W. (editor), “Industrial Gases Processing”, Weinheim, Wiley-VCH 2008 (in particular Chapter 2.2.5, “Cryogenic Rectification”) and Kerry, F. G., “Industrial Gas Handbook—Gas Separation and Purification”, Boca Raton, CRC Press 2006 (in particular Chapter 3, “Air Separation Technology”).

For characterizing pressures and temperatures, the present application uses the terms “pressure level” and “temperature level”, with the intention of indicating that pressures and temperatures in a corresponding installation do not have to be used in the form of exact pressure and temperature values in order to realize the inventive concept. However, such pressures and temperatures are typically within certain ranges, which lie for example at ±1%, 5%, 10%, 20% or even 50% around a mean value. Corresponding pressure levels and temperature levels may in this case lie in disjunct ranges or ranges that overlap one another. In particular, for example, pressure levels include unavoidable pressure losses or likely pressure losses, for example as a result of cooling effects or line losses. The same applies correspondingly to temperature levels. The pressure levels indicated here in bara are absolute pressures in bar.

### ADVANTAGES OF THE INVENTION

The present invention proposes a method for storing and recovering energy in which, in an energy storage period, an air liquefaction product is formed and, in an energy recovery period, a pressurized stream is formed and expanded to perform work by using at least part of the air liquefaction product.

As already mentioned, in the context of this application an air liquefaction product is understood as meaning any desired product in a liquid state that can be produced by compressing and cryogenically cooling air. The present invention is described below in particular with reference to liquid air as the air liquefaction product, but it is also suitable for other air liquefaction products, in particular oxygen-containing air liquefaction products. By contrast with the methods and devices mentioned at the beginning, in the case of which an oxygen-rich fluid is introduced into a gas turbine to assist oxidation reactions, an oxygen-containing air liquefaction product with (significantly) below 40, 35 or 30 mole percent of oxygen, for example with the oxygen content of natural air, is advantageously used in the present case. A distillative separation of an air liquefaction product is consequently not required.

The terms “energy storage period” and “energy recovery period” have already been explained at the beginning. They are understood in particular as meaning time periods that do not overlap one another. This means that the measures described hereinafter for the energy storage period are typically not carried out during the energy recovery period, and vice versa. It may however also be envisaged to carry out at least some of the measures described for the energy storage period at the same time as the measures described for the energy recovery period for example in a further time period, for example in order to ensure greater continuity in the operation of a corresponding installation. For example, a pressurized stream may also be fed to an energy production unit and expanded to perform work in this unit in an energy storage period, for example in order to be able to operate continuously the expansion devices used here. The energy storage period and the energy recovery period respectively correspond to an operating mode or process mode of a corresponding installation or a corresponding method.

The present invention comprises, for the formation of the air liquefaction product, compressing air in an air conditioning unit, at least by means of at least one isothermally operated compressor device, and adsorptively purifying the air by means of at least one adsorptive purification device at a superatmospheric pressure level. The compressed and adsorptively purified air is subsequently liquefied, starting from a temperature level in a range of 0 to 50° C., at which it leaves the air conditioning unit or an isothermally operated compressor device provided there, in a first fraction in a fixed-bed cold storage unit and in a second fraction in a counterflow heat exchanger unit at a liquefaction pressure level in a range of 40 to 100 bare. For the formation of the air liquefaction product, the liquefied air is subsequently expanded in at least one cold production unit, it being possible in particular for the first and second fractions to be reunited with one another beforehand.

In the context of the present invention, for the formation of the pressurized stream, a vaporization product is produced from at least part of the liquefaction product at a vaporization pressure level, which deviates by no more than 5 bar, in particular by no more than 4 bar, 3 bar, 2 bar or 1 bar, from the liquefaction pressure level, in the fixed-bed cold storage unit. The liquefaction pressure level and the vaporization pressure level may also correspond to one another. For the formation of the pressurized stream, a fluid stream is then formed from at least part of the vaporization product and is conducted through at least one combustion device, in which a fuel is burned.

An essential aspect of the present invention is, during the formation of the pressurized stream, that of conducting a corresponding fluid stream through at least one combustion device, for example at least one combustion chamber. In the combustion device, a fuel is burned in the atmosphere that is formed by the fluid stream. The pressurized stream thereby formed is consequently made up of the components of the fluid stream that are not converted during the combustion of the fuel (for example nitrogen) and corresponding combustion products (for example carbon dioxide). As mentioned, the present invention is suitable in particular for use with air liquefaction products that contain oxygen. Therefore, no additional, for example externally provided, oxygen has to be supplied for the combustion in the combustion device. Liquid or gaseous hydrocarbons and hydrocarbon mixtures, for example natural gas and/or methane, are suitable for example as the fuel.

Supplying and burning a fuel can have the effect of forming a pressurized stream, which is provided at a very much higher pressure level than is the case in conventional methods. The method according to the invention consequently allows not only the recovery of the energy stored during the forming of the air liquefaction product (apart from efficiency losses) but also the generation of further energy by burning the fuel. Such a method proves to be much more cost-efficient than methods of the prior art, such as are described for example in EP 2 397 669 A2 and US 2012/0216520 A1, since a considerably greater amount of electrical power (almost twice as much) can be generated from the same amount of air.

As mentioned, in the context of the present invention it is envisaged to operate the fixed-bed cold store in the energy storage mode and the energy recovery mode at the same or similar pressure levels (the liquefaction pressure level and the vaporization pressure level) in a range from 40 to 100 bara. As a result, pressure fluctuations within the fixed-bed store are avoided and its mechanical stability is increased, or requirements for its mechanical strength are significantly reduced. In this case, for the formation of the air liquefaction product, the air in the at least one air conditioning unit is compressed to a corresponding pressure level, which may be at subcritical or supercritical pressure. In the fixed-bed cold storage unit and the counterflow heat exchanger unit, a corresponding high-pressure air stream can consequently be transformed from the supercritical state (without classic phase transition) or the subcritical state into the liquid state. Both transitions are subsumed here under the term “liquefaction”. The same also applies correspondingly to the already explained formation of the vaporization product by “vaporization”.

As mentioned, in the context of the present invention it is also envisaged to feed the first fraction and the second fraction of the compressed and adsorptively purified air to the fixed-bed cold storage unit and the counterflow heat exchanger unit at a temperature level from 0 to 50° C. The feeding consequently takes place advantageously at ambient temperature, which makes particularly advantageous operation of the fixed-bed cold storage unit possible.

This is possible in particular because, in the context of the method according to the invention, as mentioned, an air conditioning unit with at least one isothermally operated compressor device is used. An isothermally operated compressor device, which may have one or more compressor stages or compressors in the sense explained above, is distinguished by the fact that a compressed stream fed to it and a compressed stream taken from it have a substantially identical temperature level, by contrast with adiabatically operated compressors, in the case of which the compression product has a significantly higher temperature than the stream fed into the compressor unit. For example, an isothermally operated compressor unit has intercoolers and aftercoolers.

In the context of the method according to the invention, furthermore, as likewise mentioned, an air conditioning unit with at least one adsorptive purification device operated at a superatmospheric pressure level is used. As mentioned, the air conditioning unit used in the context of the present invention uses a number of pressure stages to compress the air supplied. The adsorptive purification device may be used or provided on any of these pressure stages. For example, a purification device at a final pressure level that is provided by the air conditioning unit can be made to be of a particularly small size because, as a result of the compression, small air masses have to be purified. In the context of the present invention, an adsorptive purification device may comprise one or more adsorptive purification vessels, as explained more specifically in the context of the description of the figures.

Because in the context of the present invention the air liquefied in the energy storage period in the fixed-bed cold storage unit and the counterflow heat exchanger unit is expanded in a cold production unit, the provision of additional cold is made possible, compensating for example for losses of cold in a corresponding installation, for example in a storage tank for receiving the air liquefaction product. An evaporation product formed during the expansion may also be used as a regenerating gas, as explained below.

In the method according to the invention, to recover the energy, the fluid stream that is conducted through the at least one combustion device is advantageously expanded in at least one generator turbine as the pressurized stream mentioned. As mentioned, a generator turbine is understood here as meaning any expansion machine that is coupled to a generator. The use of a generator turbine allows a flexible recovery of energy in the form of electric power. In principle, the invention may however also comprise the use of other measures for recovering the energy, for example the operation of a hydraulic store that is filled by means of an expansion machine or a pump connected thereto.

With particular advantage, at least one expansion turbine of at least one gas turbine unit is used as the at least one generator turbine. As explained, a gas turbine unit comprises a compression stage and an expansion stage, which are connected to one another by way of a common shaft and are connected to a generator. The expansion stage of a gas turbine unit consequently forms a generator turbine in the sense explained above. A gas turbine unit makes particularly effective recovery of electrical energy possible, because a particularly advantageous pressure increase is possible in a combustion chamber after a compression has already taken place beforehand by way of the compression stage. Alternatively or in addition, one or more combustion and/or hot gas turbine units may also be used.

The method according to the invention advantageously comprises heating, expanding and/or compressing the fluid stream at least one (further) time before it is conducted through the combustion chamber. For example, the fluid stream formed from at least part of the vaporization product may be initially conducted through a heat exchanger, heated therein, and subsequently expanded in a generator turbine, and only then fed into the combustion chamber or into a combustion stage of a generator turbine. In this way, the respective (possibly latent) energy content of a corresponding stream can be used particularly effectively.

Advantageously, in a regeneration phase the at least one adsorptive purification device is fed a regenerating gas, which is formed from part of the air that is previously compressed and adsorptively purified in the air conditioning unit. A corresponding regenerating gas is advantageously heated before its use, as also further explained hereinafter. If only one purification vessel is present, a regeneration phase of an adsorptive purification device may be carried out whenever no purifying capacity has to be provided by the purification device, for example in an energy recovery period. If a number of alternately operable purification vessels are present, they can be regenerated independently of the respectively applicable time period.

The regenerating gas may be formed either during the energy storage period from at least part of an evaporation product formed during the expansion of the liquefied air or during the energy recovery period from at least part of the vaporization product.

Advantageously, an evaporation product formed during the expansion of the liquefied air is conducted through the counterflow heat exchanger unit and thereby heated. The evaporation product serves in this case for cooling the second fraction, conducted through the counterflow heat exchanger unit, of the air that is compressed and adsorptively purified in the air conditioning unit. Corresponding cold can consequently be advantageously used. Corresponding fluid can also be used as the regenerating gas.

Advantageously, in the context of the method according to the invention at least one cold transfer medium that is provided by means of an external cold circuit and/or is formed by expansion from part of the air previously compressed and adsorptively purified in the air conditioning unit is conducted through the counterflow heat exchanger unit. In the latter case, a greater amount of air than is needed for the formation of the air liquefaction product and its storage can for example be compressed and adsorptively purified by means of the air conditioning unit. The corresponding “surplus” air may possibly be cooled down in the counterflow heat exchanger unit to an intermediate temperature and subsequently expanded to provide cold and be conducted through the counterflow heat exchanger unit from the cold end to the warm end. In this way, the required cold demand can be covered without additional devices. On the other hand, the use of an external cold circuit makes a fully independent provision of cold possible.

An installation which is designed for storing and recovering energy by forming an air liquefaction product in an energy storage period and generating, and expanding to perform work, a pressurized stream formed by using part of the air liquefaction product in an energy recovery period is likewise the subject of the present invention.

The installation has means which are designed, for the formation of the air liquefaction product, to compress air in an air conditioning unit, at least by means of at least one isothermally operated compressor device, and adsorptively purify the air by means of at least one adsorptive purification device at a superatmospheric pressure level, to liquefy the compressed and adsorptively purified air, starting from a temperature level in a range of 0 to 50° C., in a first fraction in a fixed-bed cold storage unit and in a second fraction in a counterflow heat exchanger unit at a liquefaction pressure level in a range of 40 to 100 bara, and subsequently to expand the liquefied air in at least one cold production unit.

The means are also designed, for the formation of the pressurized stream, to produce a vaporization product from at least part of the liquefaction product at a vaporization pressure level, which deviates by no more than 5 bar, in particular no more than 4 bar, 3 bar, 2 bar or 1 bar, from the liquefaction pressure level, in the fixed-bed cold storage unit and to form a fluid stream from at least part of the vaporization product and conduct it through at least one combustion device, in which a fuel is burned.

Such an installation advantageously has all of the means that enable it to carry out the method explained in detail above. Such an installation therefore profits from the advantages of a corresponding method, to which reference is therefore expressly made.

The invention is explained more specifically with reference to the accompanying drawings, which show preferred embodiments of the invention.

### BRIEF DESCRIPTION OF THE DRAWINGS

FIGS. 1A and 1B show an installation according to one embodiment of the invention in an energy storage period and an energy recovery period.

FIGS. 2A to 2F show an air conditioning unit and an energy production unit according to embodiments of the invention.

FIGS. 3A and 3B show cooling devices for air conditioning units according to embodiments of the invention.

FIG. 4 shows an air purification device for an air conditioning unit according to one embodiment of the invention.

FIG. 5 shows a compressor device with a regenerating gas preheating device for an air conditioning unit according to one embodiment of the invention.

FIGS. 6A and 6B show an air purification device in the energy storage period and the energy recovery period for an air conditioning unit according to specific embodiments of the invention.

FIG. 7 shows a regenerating gas preheating device for an air conditioning unit according to a specific embodiment of the invention.

FIGS. 8A to 8C show installations according to embodiments of the invention and illustrate details of an associated counterflow heat exchanger unit.

### EMBODIMENTS OF THE INVENTION

In the figures, elements, apparatuses, devices and fluid streams that correspond in principle to one another are illustrated by the same designations and, for the sake of overall clarity, are not newly explained in all cases.

A large number of valves are shown in the figures, some connected to allow a flow to pass through and some connected to stop a flow. Valves connected to stop a flow are crossed through in the figures. Fluid streams that are interrupted by valves connected to stop a flow and correspondingly deactivated devices are mainly illustrated by dashed lines. Streams that are in a gaseous or supercritical state are illustrated by white (not filled-in) triangular arrowheads, liquid streams by black (filled-in) triangular arrowheads.

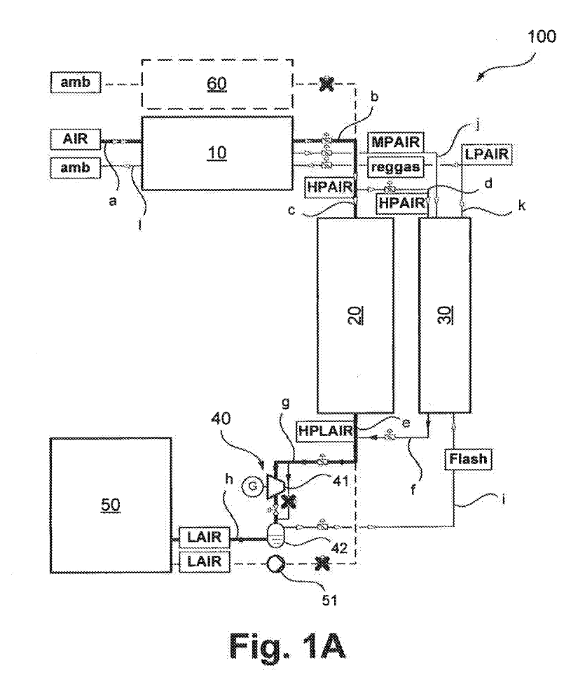

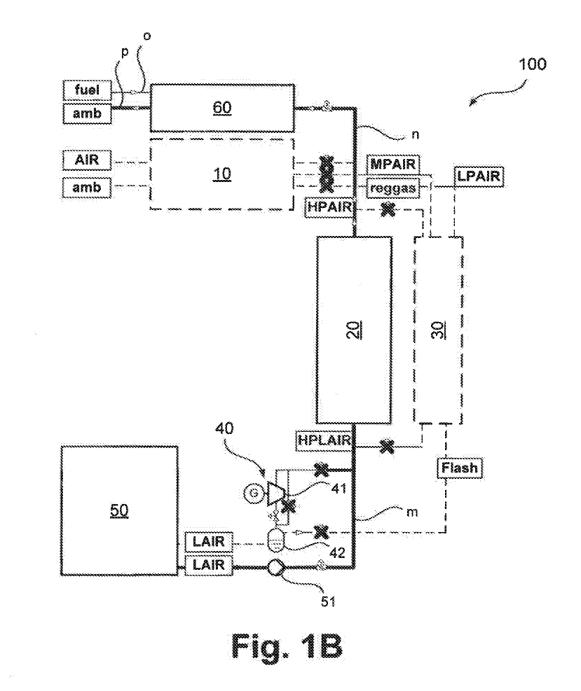

In FIGS. 1A and 1B, an installation according to a particularly preferred embodiment of the invention is shown in an energy storage period (FIG. 1A) and an energy recovery period (FIG. 1B) and is denoted overall by 100.

The installation 100 comprises as central components an air conditioning unit 10, a fixed-bed cold storage unit 20, a counterflow heat exchanger unit 30, a cold production unit 40, a liquid storage unit 50 and an energy production unit 60.

Here and hereinafter, some or all of the components shown may be present in any desired number and be charged for example in parallel with corresponding sub-streams.

In the energy storage period illustrated in FIG. 1A, an air stream a (AIR, feed air) is fed to the installation 100 and compressed and purified in the air conditioning unit 10. A stream b that has been correspondingly compressed and purified, in particular freed of water and carbon dioxide, is at a pressure level of for example 40 to 100 bara and is also referred to hereinafter as the high-pressure air stream b.

In the energy storage period of the installation 100 that is illustrated in FIG. 1A, the high-pressure air stream b is divided into a first sub-stream c and a second sub-stream d. It goes without saying that, in corresponding installations, it may also be provided that a corresponding high-pressure air stream b is divided into more than two sub-streams.

The air of the sub-streams c and d (HPAIR) is fed on the one hand to the fixed-bed cold storage unit 20 and on the other hand to the counterflow heat exchanger unit 30 at the already mentioned pressure level of the high-pressure air stream b and respectively liquefied in the fixed-bed cold storage unit 20 and the counterflow heat exchanger unit 30. The air of the correspondingly liquefied streams e and f (HPLAIR) is combined to form a collective stream g. The pressure level of the streams e, f and g corresponds substantially, i.e. apart from line losses and cooling losses, to the pressure level of the high-pressure air stream b.

The liquefied air of the stream g, that is to say an air liquefaction product, is expanded in the cold production unit 40, which may for example comprise a generator turbine 41. The expanded air may be transferred for example into a separator vessel 42, in the lower part of which a liquid phase is separated and in

The liquid phase can be drawn off from the separator vessel 42 as stream h (LAIR) and transferred into the liquid storage unit 50, which may for example comprise one or more isolated storage tanks. The pressure level of the stream h is for example at 1 to 16 bara. The gas phase drawn off from the upper part of the separator vessel 42 as stream i (flash) may be conducted in counterflow to the stream f through the counterflow heat exchanger unit 30 and subsequently, in the form of the stream k (LPAIR, reggas), be used in the air conditioning unit 10 as regenerating gas. The pressure level of the stream k is for example at atmospheric pressure to about 2 bara. Downstream, a corresponding stream I is typically at atmospheric pressure (amb) and may be discharged into the surroundings.

During the energy storage period illustrated in FIG. 1A, the cold stored in the fixed-bed cold storage unit 20 is used for liquefying the air of the sub-stream c. Additionally provided is the counterflow heat exchanger unit 30, in which additional air, specifically air of the sub-stream d, can be liquefied in counterflow to for example a cold stream i, which can be obtained from expanded, evaporated air of the stream g. Use of the counterflow heat exchanger unit 30 makes more flexible operation of the installation 100 possible than would be the case when using only the fixed-bed cold storage unit 20.

Furthermore, a stream j, which is likewise provided by means of the air conditioning unit 10 and is at a pressure level of for example 5 to 20 bara, is conducted through the counterflow heat exchanger unit 30. This stream j is also referred to hereinafter as the medium-pressure air stream (MPAIR).

In the energy recovery period illustrated in FIG. 1B, liquefied air (LAIR) previously stored in the energy storage period, that is to say the air liquefaction product, is removed from the liquid storage unit 50 and increased in pressure by means of a pump 51. A stream m (HPLAIR) obtained in this way is conducted through the fixed-bed cold storage unit 20 and thereby evaporated or transformed from the liquid state into the supercritical state (“vaporized”). A vaporization product is therefore formed, from which a fluid stream is formed completely, as shown here, or else only partially. The stream m is in this case at a comparable pressure level to the already previously explained high-pressure air stream b. The stream n obtained by the evaporation or the transformation from the liquid state into the supercritical state in the fixed-bed cold storage unit 20 is consequently also a high-pressure air stream.

In the energy recovery period illustrated in FIG. 1B, a fluid stream is formed from the high-pressure air stream n in the energy production unit 60, is heated by using fuel fed to the energy production unit 60 in a stream o and is expanded to obtain electrical energy. In this way, a pressure-increased pressurized stream is formed from the fluid stream, which for its part may also already have been pressurized. As also illustrated below, the expansion and the heating of a corresponding stream can take place in various ways. A correspondingly expanded stream p is for example at atmospheric pressure (amb) and can for example be passed on to an exhaust gas purification unit.

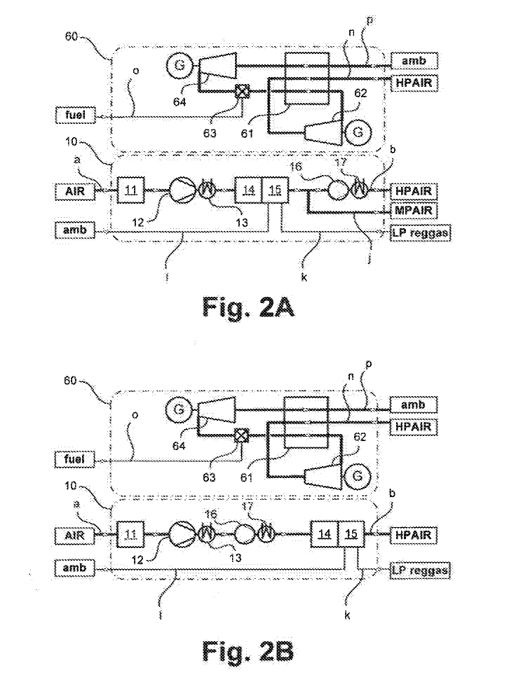

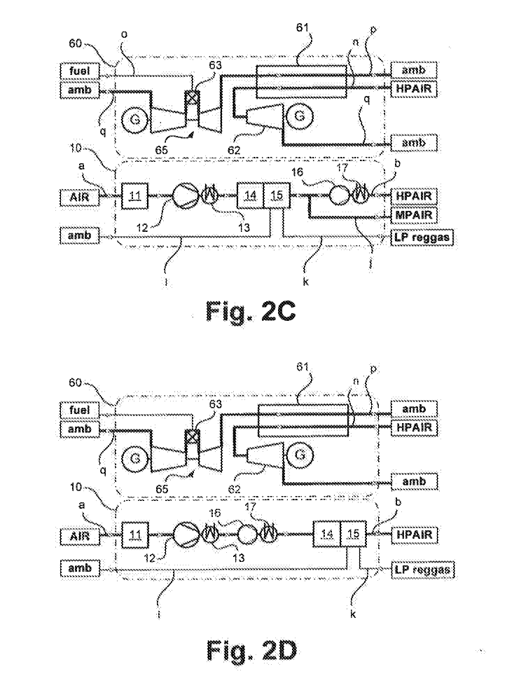

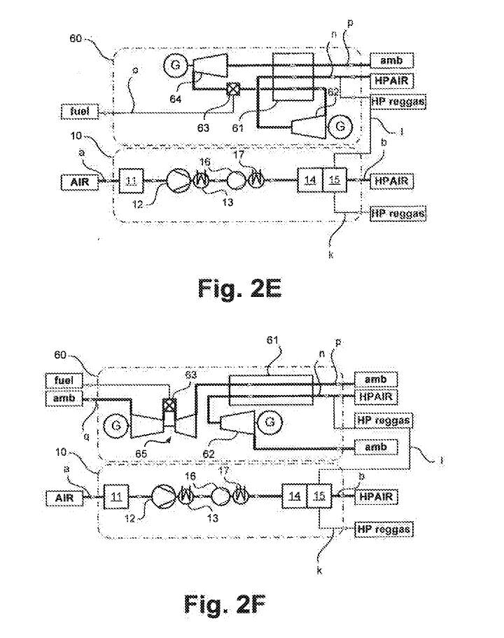

The air conditioning units 10 and energy production units 60 illustrated in FIGS. 2A to 2F are intended for use in installations 100 according to various embodiments of the invention, for example in the installation 100 shown in FIGS. 1A and 1B.

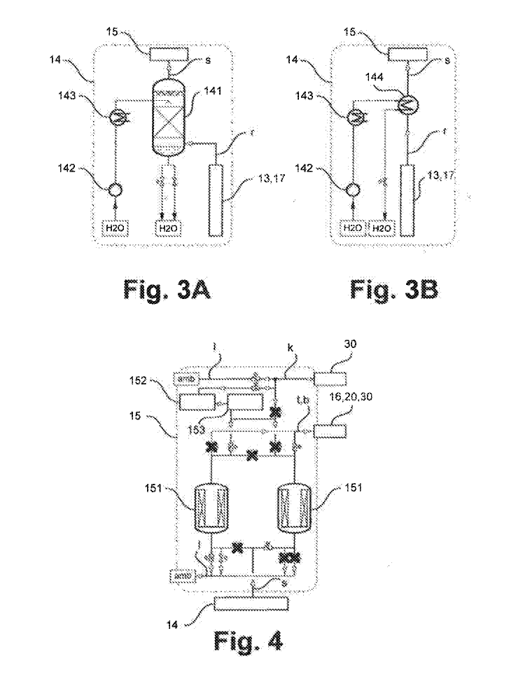

According to the embodiment shown in FIG. 2A, the already explained stream a is sucked in by way of a filter 11 and compressed by means of a compressor device 12, for example by means of a multi-stage axial compressor. After cooling down in an aftercooling device 13, for example in a cooler 13 operated with cooling water, the compressed and then cooled stream a is fed to a cooling device 14 and subsequently to an air purification device 15. Examples of corresponding cooling devices 14 and air purification devices 15 are illustrated more specifically in the subsequent FIGS. 3A, 3B and 4.

Downstream of the air purification device 15, a sub-stream of the air of the stream a at an intermediate pressure is removed as the already explained stream j. Air of the stream a that is not discharged as medium-pressure air stream j is compressed further in a further compressor device 16. The compressor device 16 may also be formed as a multi-stage axial compressor.

In the context of the present invention, in particular the compressor device 12 and the compressor device 16 may be charged with air at the same temperature. In particular, the compressor devices 12 and/or 16 may be operated isothermally.

Arranged downstream of the compressor device 16 is a further aftercooling device 17. Air compressed in the compressor device 16 and cooled in the aftercooling device 17 is provided as the already explained high-pressure air stream b.

For operating or regenerating the air purification device 15, the already explained regenerating gas stream k may be fed to it and the likewise explained stream I discharged from it.

As already explained with reference to FIGS. 1A and 1B, the high-pressure air stream b and the medium-pressure air stream j through the air-conditioning unit 10 are typically only provided in the energy storage period. In this energy storage period, the energy production unit 60 is not in operation. Conversely, in the energy recovery period, typically only the energy production unit 60 is in operation, but not the air conditioning unit 10. FIGS. 2A to 2F consequently show the energy storage period and the energy recovery period in one representation.

In the energy recovery period, the high-pressure air stream n is fed to the energy production unit 60 and heated in a recuperator system 61, which may for example be formed by a number of heat exchangers. The heated high-pressure air stream n is expanded in a generator turbine 62 to obtain electrical energy and subsequently conducted once again through the recuperator system 61 and heated in it.

A further heating of the expanded high-pressure air stream n takes place by means of fuel of the stream o, which can be burned in a combustion device 63, for example a combustion chamber. The correspondingly heated stream is fed to a further generator turbine 64 and expanded in it to obtain electrical energy. Part of the heat of the stream expanded in the generator turbine 64 is transferred in the recuperator system 61 to the already mentioned streams conducted through it. Downstream of the recuperator system 61, the stream expanded in the further generator turbine 64 is purified as stream p, as mentioned, for example in an exhaust gas purification unit.

The variant illustrated in FIG. 2B differs from this substantially in the design of the air conditioning unit 10. In particular, the cooling device 14 and the air purification device 15 are provided here downstream of the compressor device 16 and the associated aftercooling device 17, that is to say in a region of higher pressure. This is possible because no medium-pressure air stream j that likewise has to be purified is formed here. The cooling device 14 and the air purification device 15 are designed for a corresponding higher pressure. As mentioned, this makes it possible to make the air purification device 15 be of a smaller size.

With regard to the air conditioning unit 10, the variant illustrated in FIG. 2C corresponds substantially to the variant illustrated in FIG. 2A. However, illustrated in the energy production unit 60 is a gas turbine unit 65, the compression stage and expansion stage of which may be coupled to a generator by way of a common shaft, but are not individually denoted. In the variant illustrated in FIG. 20, the high-pressure air stream n is likewise conducted through a recuperator system 61 and expanded in a generator turbine 62. The correspondingly expanded stream, here denoted by q, is fed to the compression stage of the gas turbine unit 65, subsequently heated by fuel of the stream o in an interposed combustion device 63 and then expanded in an expansion stage of the gas turbine unit 65. The heat produced in the gas turbine unit 65 or the combustion device 63 is at least partly transferred to the high-pressure air stream n in the recuperator system 61.

The variant illustrated in FIG. 2D corresponds substantially to a combination of the air conditioning unit 10 shown in FIG. 2B and the energy production unit 60 shown in FIG. 2C. For details, reference is therefore made to the previously explained FIGS. 2B and 2C.

The variant illustrated in FIG. 2E differs from the variant illustrated in FIG. 2B substantially in the use of the regenerating gas stream k. In the variant illustrated in FIG. 2E, this regenerating gas stream k is not provided as a low-pressure air stream but as a high-pressure air stream. It may for example be formed from part of the high-pressure air stream n, i.e. during the energy recovery period. Here, the regenerating gas stream k is first conducted through the air purification device 15 (which in the energy recovery period is not operating in a purifying mode and consequently can be regenerated) and subsequently combined with the high-pressure air stream n. Components contained in the stream I downstream of the air purification device 15, such as water and carbon dioxide, generally prove to be unproblematic on account of the temperatures that prevail in the energy production unit 60. The variant illustrated in FIG. 2E has the advantage that less compressed air is lost.

The variant illustrated in FIG. 2F likewise comprises the already explained different use of the regenerating gas stream k that is already shown in FIG. 2E. As shown in FIG. 2F, this variant is suitable in the same way for use with an energy production unit 60 with a gas turbine unit 65, not just with the expansion of the stream n according to FIG. 2A or FIG. 2B that is shown in FIG. 2E.

In FIG. 3A, a cooling device 14 for use in an air conditioning unit 10, such as that illustrated for example in the previously shown FIGS. 2A to 2F, is shown in detail. The cooling device 14 may be arranged downstream of the aftercooling device 13 (cf. FIGS. 2A and 2C) or downstream of the aftercooling device 17 (cf. FIGS. 2B, 2D, 2E and 2F). A corresponding stream, here denoted by r, is fed into a lower region of a direct contact cooler 141. The stream r corresponds to the correspondingly compressed stream a (cf. FIGS. 2A to 2F). In an upper region of the direct contact cooler 141, a water stream (H2O), which is conducted through an (optional) cooling device 143 by means of a pump 142, is introduced. Water can be drawn off from a lower region of the direct contact cooler 141. A correspondingly cooled stream s is drawn off from the head of the direct contact cooler 141 and can for example subsequently be transferred into an air purification device 15 (cf. FIGS. 2A to 2F).

As a departure, according to the variant of the cooling device 14 that is illustrated in FIG. 3B, a direct contact cooler 141 is not provided, but instead a heat exchanger 144. This heat exchanger 144 may also be operated with a water stream, which is conducted through an (optional) cooling device 143 by means of a pump 142.

In FIG. 4, an air purification device 15, which is suitable in particular for use in an air conditioning unit 10, such as that shown in FIGS. 2A to 2D, is illustrated in detail. A cooled stream s, originating for example from a cooling device 14 (cf. FIGS. 2A to 2D and FIGS. 3A and 36), may be conducted here alternately through two adsorber vessels 151, which for example comprise a molecular sieve. The stream s corresponds in this case to the correspondingly compressed and cooled stream a (cf. FIGS. 2A to 2D). In the adsorber vessels 151, water and carbon dioxide in particular are removed from the stream s. A correspondingly obtained stream t, which for example in the case of the embodiments illustrated in FIGS. 2B and 2D may correspond to the stream b, is fed to the device respectively arranged downstream of it, for example the next compressor device (cf. FIGS. 2A and 2C) or the fixed-bed cold storage unit 20 or the counterflow heat exchanger unit 30 (cf. FIGS. 2B and 2D).

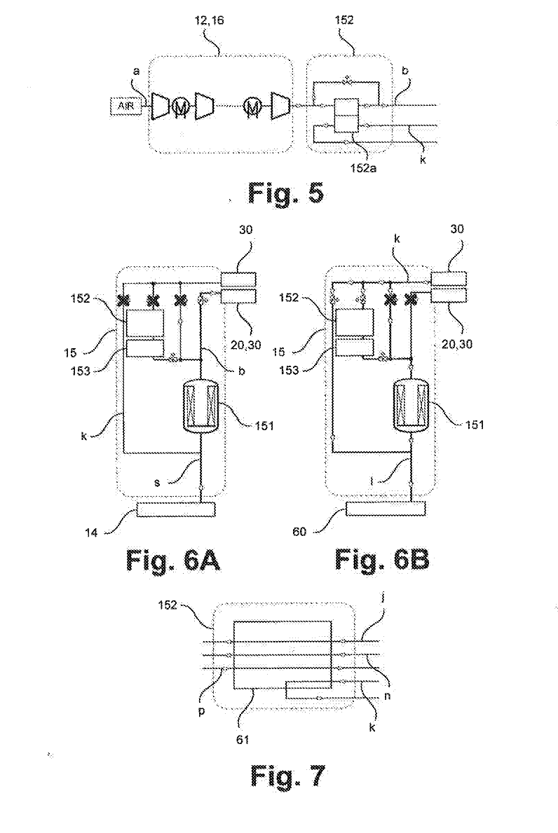

The adsorber vessel 151 that is respectively not being used for purifying the stream s may be regenerated by means of the already explained regenerating gas stream k. The stream k may in this case first be fed to an optional regenerating gas preheating device 152, which is illustrated in an example in the subsequent FIG. 5. In a downstream regenerating gas heating device 153, which may for example be operated electrically and/or with hot steam, the regenerating gas stream k is heated further and conducted through the adsorber vessel 151 that is respectively to be regenerated. Downstream of the adsorber vessel 151 to be regenerated there is a corresponding stream I. The same applies if no regenerating gas is needed at the time shown, because in this case a corresponding stream I is discharged directly from the air purification device 15 (see stream I in the upper part of FIG. 4).

In FIG. 5, the operation of a regenerating gas preheating device 152 according to one embodiment of the invention is illustrated in particular. The regenerating gas preheating device 152 may for example replace or supplement one of the aftercooling devices 13 or 17, and consequently be arranged downstream of an air compressor device 12 or 16. An air stream heated as a result of a corresponding compression may be conducted through a heat exchanger 152a of the regenerating gas preheating device 152 or past it, and thereby transfer heat to a regenerating gas stream k.

Shown in FIGS. 6A and 6B are air purification devices 15, which are suitable in particular for the embodiments of the present invention illustrated in FIGS. 2E and 2F and the air conditioning devices shown in them. In FIGS. 6A and 6B, the energy storage period (FIG. 6A) and the energy recovery period (FIG. 6B) are illustrated, the purification of a corresponding stream s taking place in the energy storage period. Because in the energy recovery period a corresponding installation 100 is not fed air in the form of the stream a, and consequently the air conditioning device 10 is not in operation, at such times a corresponding adsorber vessel 151 is available for regeneration. The embodiment illustrated in FIGS. 6A and 6B therefore has the particular advantage that only one corresponding adsorber vessel 151 has to be provided, and not two, which according to FIG. 4 are operated alternately. As shown in FIGS. 2E and 2F, this requires the provision of a corresponding regenerating gas stream k during the energy recovery period.

Here, too, a regenerating gas stream k may be preheated in an optional regenerating gas preheating device 152, which is illustrated in detail in FIG. 7, and heated in a regenerating gas heating device 153.

In the energy recovery period illustrated in FIG. 6B, correspondingly heated regenerating gas is consequently conducted through the adsorber vessel 151; in the energy storage period, this regenerating gas vessel 151 is available for purifying the stream s.

As mentioned, illustrated in FIG. 7 is a regenerating gas preheating device 152, which is suitable in a particular way for use in the air purification device 15 shown in FIGS. 6A and 6B. The regenerating gas stream k is conducted here through the recuperator system 61 already illustrated in FIGS. 2E and 2F in counterflow in relation to the explained stream n (and additionally in relation to the medium-pressure air stream j).

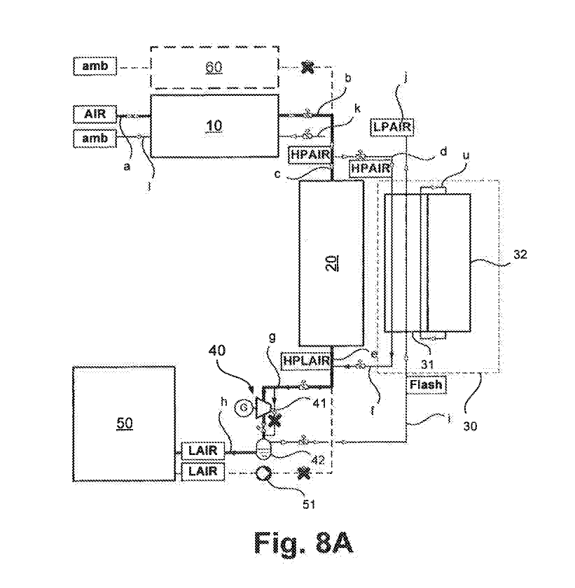

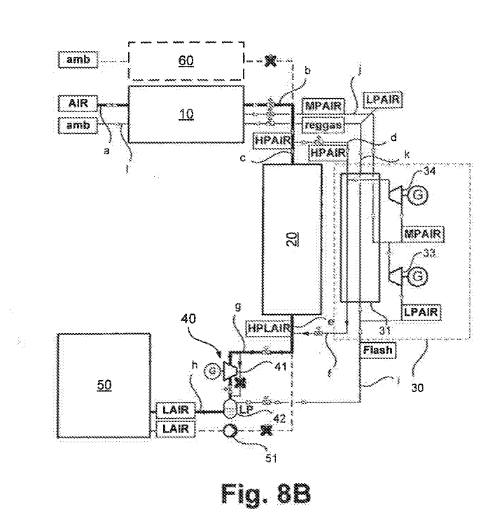

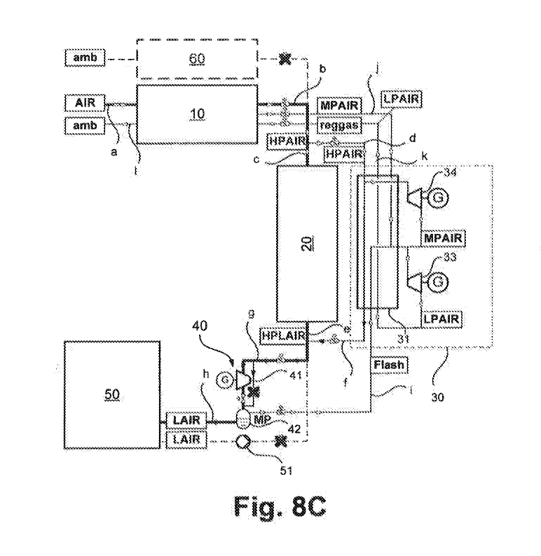

FIGS. 8A to 8C illustrate installations according to preferred embodiments of the invention in each case in the energy storage period. The installations correspond substantially to the previously explained embodiments with respect to the fixed-bed cold storage unit 20, the cold production unit 40, the liquid storage unit 50 and the energy production unit 60, but differ in particular with regard to the counterflow heat exchanger unit 30, which is therefore explained below.

According to the embodiment illustrated in FIG. 8A, the counterflow heat exchanger unit 30 may for example be operated by means of a stream u, which is conducted from the cold end to the warm end through one or more heat exchangers 31 of the counterflow heat exchanger unit 30.

To provide the stream u, a separate liquefaction process 32, operated by means of dedicated compressors, i.e. compressors provided in addition to the air-conditioning unit 10, may for example be implemented.

In the embodiment shown in FIG. 8B, which corresponds substantially to the embodiment shown in FIGS. 1A and 1B, on the other hand, a medium-pressure air stream j may be fed to the the counterflow heat exchanger unit 10 and fed into the heat exchanger 31 at the warm end. The stream j may be removed from the heat exchanger 31 at an intermediate temperature and expanded in a generator turbine 33. A further sub-stream of the high-pressure air stream b, or its sub-stream d, may likewise be removed from the heat exchanger 131 at an intermediate temperature and expanded in a further generator turbine 34. Said flows may be combined and conducted together through the generator turbine 33. Cold released by the expansion is used for the liquefaction of the stream c (see FIGS. 1A and 1B), in that corresponding streams are fed on the cold side to the heat exchanger 31 together with the already explained stream i.

In a variant shown in FIG. 8C, the stream i is fed on the cold side to the heat exchanger 31 of the counterflow heat exchanger unit 30, removed at an intermediate temperature, combined with the medium-pressure air stream j, which has likewise been conducted through the heat exchanger 31 up to an intermediate temperature, and subsequently expanded in the generator turbine 33. Previously, corresponding air may be combined with a sub-stream of the stream c, as already shown in FIG. 8B.

The embodiments illustrated in FIGS. 8B and 8C are suitable in particular for the use of streams i at different pressure levels.

1. A method for storing and recovering energy in which, in an energy storage period, an air liquefaction product is formed and, in an energy recovery period, a pressurized stream is formed and expanded to perform work by using at least part of the air liquefaction product, the method comprising,
for the formation of the air liquefaction product,
compressing air in an air conditioning unit, at least by means of at least one isothermally operated compressor device, and adsorptively purifying the air by means of at least one adsorptive purification device at a superatmospheric pressure level,
liquefying the compressed and adsorptively purified air, starting from a temperature level in a range of 0 to 50° C., in a first fraction in a fixed-bed cold storage unit and in a second fraction in a counterflow heat exchanger unit at a liquefaction pressure level in a range of 40 to 100 bara, and
subsequently expanding the liquefied air in at least one cold production unit,
and, for the formation of the pressurized stream,
producing a vaporization product from at least part of the liquefaction product at a vaporization pressure level, which deviates by no more than 5 bar from the liquefaction pressure level, in the fixed-bed cold storage unit, and
forming a fluid stream from at least part of the vaporization product and conducting it through at least one combustion device, in which a fuel is burned.

2. The method as claimed in claim 1, which comprises expanding the fluid stream conducted through the at least one combustion device in at least one generator turbine as the pressurized stream.

3. The method as claimed in claim 2, which comprises using at least one expansion turbine of at least one gas turbine unit as the at least one generator turbine.

4. The method as claimed in claim 1, which comprises heating, expanding and/or compressing the fluid stream at least one time before it is conducted through the combustion device.

5. The method as claimed in claim 1, which comprises feeding to the at least one adsorptive purification device a regenerating gas, which is formed from part of the air that is previously compressed and adsorptively purified in the air conditioning unit.

6. The method as claimed in claim 5, which comprises forming the regenerating gas during the energy storage period from at least part of an evaporation product formed during the expansion of the liquefied air.

7. The method as claimed in claim 5, which comprises forming the regenerating gas during the energy recovery period from at least part of the vaporization product.

8. The method as claimed in claim 1, which comprises conducting an evaporation product formed during the expansion of the liquefied air through the counterflow heat exchanger unit.

9. The method as claimed in claim 1, which comprises conducting at least one cold transfer medium that is provided by means of an external cold circuit and/or is formed by expansion from part of the air compressed and adsorptively purified in the air conditioning unit through the counterflow heat exchanger unit.

10. An installation, which is designed for storing and recovering energy by forming an air liquefaction product in an energy storage period and by generating, and expanding to perform work, a pressurized stream formed by using at least part of the air liquefaction product in an energy recovery period, the installation having means which are designed,
for the formation of the air liquefaction product,
to compress air in an air conditioning unit, at least by means of at least one isothermally operated compressor device, and adsorptively purify the air by means of at least one adsorptive purification device at a superatmospheric pressure level,
to liquefy the compressed and adsorptively purified air, starting from a temperature level in a range of 0 to 50° C., in a first fraction in a fixed-bed cold storage unit and in a second fraction in a counterflow heat exchanger unit at a liquefaction pressure level in a range of 40 to 100 bara, and
subsequently to expand the liquefied air in at least one cold production unit,
and, for the formation of the pressurized stream,
to produce a vaporization product from at least part of the liquefaction product at a vaporization pressure level, which deviates by no more than 5 bar from the liquefaction pressure level, in the fixed-bed cold storage unit, and
to form a fluid stream from at least part of the vaporization product and to conduct it through at least one combustion device, in which a fuel is burned.

11. The installation as claimed in claim 10, which has means that are designed for carrying out a method for storing and recovering energy.
